(19) United States
(12) Patent Application Publication
(10) Pub. No.: US 2021/0096568 A1
(43) Pub. Date: Apr. 1, 2021

(54) SYSTEM AND METHOD FOR DYNAMICALLY ADJUSTING A TRAJECTORY OF AN AUTONOMOUS VEHICLE DURING REAL-TIME NAVIGATION

(71) Applicant: Wipro Limited, Bangalore (IN)

(72) Inventors: Balaji Sunil KUMAR, Bengaluru (IN); Manas SARKAR, Barasat (IN)

(21) Appl. No.: 16/700,214

(22) Filed: Dec. 2, 2019

(30) Foreign Application Priority Data
Sep. 30, 2019 (IN) 201941039583

(51) Int. Cl. G05D 1/02; G05D 1/00; G01S 17/89

(52) U.S. Cl. CPC G05D 1/0212; G05D 1/0088; G05D 2201/0213; G01S 17/89; G05D 1/0246

(57) ABSTRACT

This disclosure relates to method and system for dynamically modifying navigation trajectory of an autonomous ground vehicle (AGV). The method may include receiving an image of a visible road region ahead of the AGV, projecting planned trajectory waypoints on the image, and segmenting the visible road region in the image into equidistant segments along a road length. For each of the equidistant segments, the method may further include determining alternate trajectory waypoints and a suggested velocity for a given segment based on the image of the given segment, a set of the planned trajectory waypoints in the given segment, an adjusted trajectory waypoint in a previous segment, and a determined velocity in the previous segment using an artificial intelligence model. Additionally, for each of the equidistant segments, the method may include determining an adjusted trajectory waypoint based on the alternate trajectory waypoints and the suggested velocity for the given segment.

### TECHNICAL FIELD

This disclosure relates generally to an autonomous ground vehicle (AGV) and more particularly to method and system for dynamically modifying navigation trajectory of the AGV during real-time navigation.

### BACKGROUND

Autonomous ground vehicles (AGVs) are increasingly deployed in a variety of indoor and outdoor settings so as to facilitate efficient transportation. An AGV may be capable of sensing the dynamic changing environment, and of accurately navigating without any human intervention. For example, the AGV may be configured to determine a global path from origin to destination for navigation, and then a finer trajectory plan for a local visible region during navigation.

Autonomous trajectory planning is typically about moving from point A to point B while avoiding collisions by accounting for known or likely environment. However, a human driver may also consider unknown or less likely scenarios while driving the vehicle. For example, a portion of the road with partial caving, a pothole filled with water, etc. may be some of the important scenarios that the human driver may consider and act upon. Thus, autonomous trajectory planning should take care of such scenarios so as to minimize wear and tear of the AGV, reduce unexpected road hazards, and increase comfort level for the passengers. In other words, when such obstacles are present on the driving path, the AGV should perform control operations so that the AGV may be safely driven by changing the driving path to avoid the obstacles.

Some of the existing techniques disclose predicting actions (e.g., optimal course of actions or likely reactions) to undertake based on sub-optimal performance of the AGV and/or changes in visible road region using artificial intelligence and/or machine-learning techniques. In some cases, the predicted actions may involve predicted trajectory. However, existing techniques are limited in their scope and utility. For example, existing techniques do not provide a navigable trajectory based on road's anomaly, vehicle's capability, etc. In other words, existing techniques do not provide exact trajectory waypoints (i.e., fine-tuned trajectory) to navigate upon.

### SUMMARY

A method of dynamically modifying a trajectory of an autonomous ground vehicle (AGV) during real-time navigation is disclosed. The method may include receiving an image of a visible road region ahead of the AGV. The method may further include projecting a plurality of planned trajectory waypoints on the image. The method may further include segmenting the visible road region in the image into a plurality of equidistant segments along a road length. For each of the plurality of equidistant segments, the method may further include determining a set of alternate trajectory waypoints and a suggested velocity for a given segment based on the image of the given segment, a set of the plurality of planned trajectory waypoints in the given segment, an adjusted trajectory waypoint in a previous segment, and a determined velocity in the previous segment using an artificial intelligence (AI) model. Additionally, for each of the plurality of equidistant segments, the method may further include determining an adjusted trajectory waypoint based on the set of alternate trajectory waypoints and the suggested velocity for the given segment.

In one embodiment, a system for dynamically modifying a trajectory of an AGV during real-time navigation is disclosed. In one example, the system may include a navigation device, which may include at least one processor and a memory communicatively coupled to the at least one processor. The memory may store processor-executable instructions, which, on execution, may cause the processor to receive an image of a visible road region ahead of the AGV. The processor-executable instructions, on execution, may further cause the processor to project a plurality of planned trajectory waypoints on the image. The processor-executable instructions, on execution, may further cause the processor to segment the visible road region in the image into a plurality of equidistant segments along a road length. For each of the plurality of equidistant segments, the processor-executable instructions, on execution, may further cause the processor to determine a set of alternate trajectory waypoints and a suggested velocity for a given segment based on the image of the given segment, a set of the plurality of planned trajectory waypoints in the given segment, an adjusted trajectory waypoint in a previous segment, and a determined velocity in the previous segment using an artificial intelligence (Al) model. Additionally, for each of the plurality of equidistant segments, the processor-executable instructions, on execution, may cause the processor to determine an adjusted trajectory waypoint based on the set of alternate trajectory waypoints and the suggested velocity for the given segment.

In one embodiment, a non-transitory computer-readable medium storing computer-executable instructions for dynamically modifying a trajectory of an AGV during real-time navigation is disclosed. In one example, the stored instructions, when executed by a processor, may cause the processor to perform operations including receiving an image of a visible road region ahead of an AGV. The operations may further include projecting a plurality of planned trajectory waypoints on the image. The operations may further include segmenting the visible road region in the image into a plurality of equidistant segments along a road length. For each of the plurality of equidistant segments, the operations may further include determining a set of alternate trajectory waypoints and a suggested velocity for a given segment based on the image of the given segment, a set of the plurality of planned trajectory waypoints in the given segment, an adjusted trajectory waypoint in a previous segment, and a determined velocity in the previous segment using an artificial intelligence (AI) model. Additionally, for each of the plurality of equidistant segments, the operations may include determining an adjusted trajectory waypoint based on the set of alternate trajectory waypoints and the suggested velocity for the given segment.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for dynamically modifying navigation trajectory of an autonomous ground vehicle (AGV) during real-time navigation, in accordance with some embodiments of the present disclosure.

FIG. 2 is a functional block diagram of the exemplary system of FIG. 1, in accordance with some embodiments of the present disclosure.

FIG. 3 is a flow diagram of an exemplary process for dynamically modifying navigation trajectory of an AGV during real-time navigation, in accordance with some embodiments of the present disclosure.

FIG. 4 is a flow diagram of a detailed exemplary process for dynamically modifying navigation trajectory of an AGV during real-time navigation, in accordance with some embodiments of the present disclosure.

FIG. 5 illustrates image annotations on multiple images used for training an AI model, in accordance with some embodiments of the present disclosure.

FIG. 6 illustrates projection of planned trajectory waypoints on an image and segmentation of visible road region in the image, in accordance with some embodiments of the present disclosure.

FIG. 7 is a block diagram of an AI model for generating alternate trajectory waypoints, in accordance with some embodiments of the present disclosure.

FIG. 8 illustrates alternate trajectory waypoints along with planned trajectory waypoints and adjusted trajectory waypoints, in accordance with some embodiments of the present disclosure.

FIG. 9 illustrates derivation of approximate trajectory waypoints towards generation of adjusted trajectory waypoints, in accordance with some embodiments of the present disclosure.

FIG. 10 illustrates derivation of adjusted trajectory waypoints to generate modified trajectory, in accordance with some embodiments of the present disclosure.

FIG. 11 is a table providing safe turn angle with respect to speed of the AGV, in accordance with some embodiments of the present disclosure.

FIG. 12 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

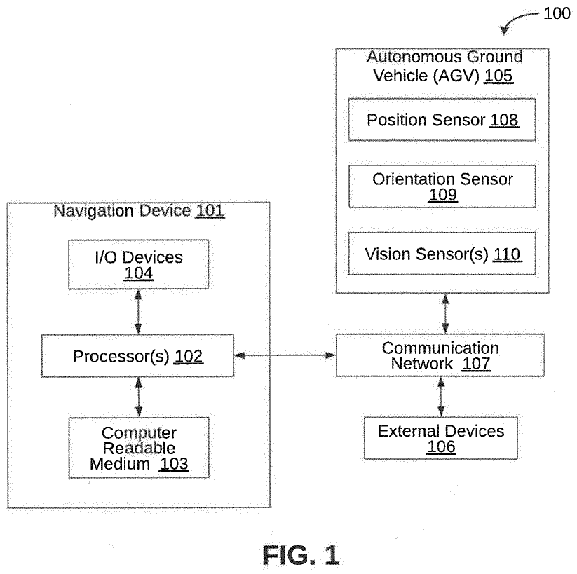

Referring now to FIG. 1, an exemplary system 100 for dynamically modifying navigation trajectory of an autonomous ground vehicle (AGV) 105 during real-time navigation, is illustrated, in accordance with some embodiments of the present disclosure. In particular, the system 100 may implement a navigation device 101 so as to dynamically modify a trajectory of the AGV during real-time navigation. As will be appreciated, the navigation device 101 may be any computing device (for example, server, desktop, laptop, notebook, netbook, tablet, smartphone, mobile phone, or the like).

Further, as will be appreciated by those skilled in the art, the AGV 105 may be any vehicle capable of sensing the dynamic changing environment, and of navigating without any human intervention. Thus, the AGV 105 may include at least a number of sensors, a vehicle drivetrain, and a processor based control system, among other components. The sensors may enable sensing the dynamic changing environment by capturing various sensor parameters. The sensors may include a position sensor 108 for acquiring instant position (i.e., current location) of the AGV 105 with respect to a navigation map (i.e., within a global reference frame), the orientation sensor 109 for acquiring instant orientation (i.e., current pose or direction) of the AGV 105 with respect to the navigation map, and one or more vision sensors 110 for acquiring instant three-dimensional (3D) image of an environment around the AGV 105. In some embodiments, the 3D image may be a 360 degree field of view (FOV) of the environment (i.e., environmental FOV) that may provide information on presence of any objects in the vicinity of the AGV 105. Further, in some embodiments, the 3D image may be a frontal FOV of a navigation path (i.e., navigational FOV) of the AGV 105. By way of example, the position sensor 108 may be a global positioning system (GPS) sensor, the orientation sensor 109 may be an inertial measurement unit (IMU) sensor, and the vision sensors 110 may be any of a light detection and ranging (LiDAR) scanner, a laser scanner, a radio detection and ranging (RADAR) scanner, a short-range RADAR scanner, a camera, or ultrasonic scanner.

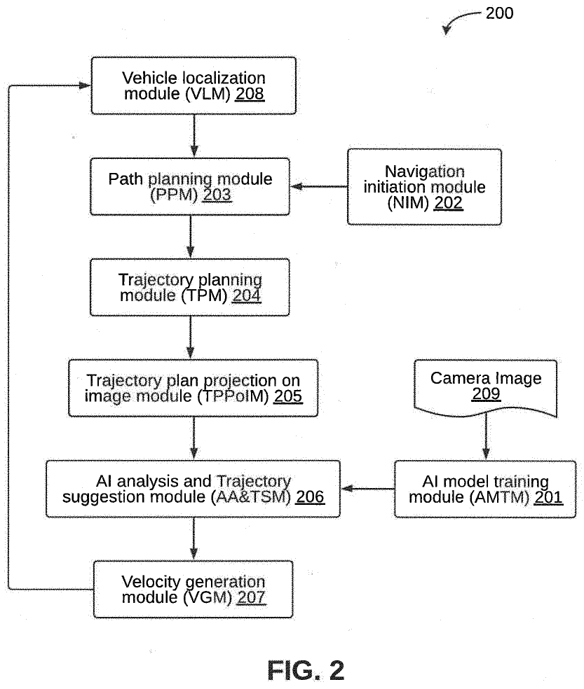

As will be described in greater detail in conjunction with FIGS. 2-11, the navigation device 101 may receive an image of a visible road region ahead of the AGV 105, project a plurality of planned trajectory waypoints on the image, and segment the visible road region in the image into a plurality of equidistant segments along a road length. For each of the plurality of equidistant segments, the navigation device 101 may determine a set of alternate trajectory waypoints and a suggested velocity for a given segment based on the image of the given segment, a set of the plurality of planned trajectory waypoints in the given segment, an adjusted trajectory waypoint in a previous segment, and a determined velocity in the previous segment using an artificial intelligence (Al) model. Additionally, for each of the plurality of equidistant segments, the navigation device 101 may determine an adjusted trajectory waypoint based on the set of alternate trajectory waypoints and the suggested velocity for the given segment.

The navigation device 101 may include one or more processors 102, a computer-readable medium (for example, a memory) 103, and an input/output (I/O) device 104. The computer-readable medium 103 may store instructions that, when executed by the one or more processors 102, cause the one or more processors 102 to dynamically modify navigation trajectory of the AGV 105 during real-time navigation, in accordance with aspects of the present disclosure. The computer-readable medium 103 may also store various data (for example, base path, trajectory plan, trajectory waypoints, image of visible road region, projection of trajectory waypoints on the image, segmented portions of the image corresponding to equidistant segments, alternate trajectory waypoints for each segment, suggested or determined velocity for each segment, approximate trajectory waypoints for each segment, adjusted trajectory waypoints for each segment, AI model, training data comprising multiple images with image annotations, safe turn angle table, and so forth) that may be captured, processed, and/or required by the navigation device 101. The navigation device 101 may interact with a user via a user interface accessible via the I/O devices 104.

The navigation device 101 may also interact with one or more external devices 106 or with the AGV 105 over a communication network 107 for sending or receiving various data. The external devices 106 may include, but may not be limited to, a remote server, a digital device, or another computing system. In some embodiments, the navigation device 101 may be part of the AGV 105.

Referring now to FIG. 2, a functional block diagram of an exemplary system 200, analogous to the exemplary system 100 of FIG. 1, is illustrated, in accordance with some embodiments of the present disclosure. The system 200 may include various modules that perform various functions so as to determine trajectory plan, to dynamically modify trajectory plan during real-time navigation, and to perform navigation of the AGV. In some embodiments, system 200 may include an AI model training module (AMTM) 201, a navigation initiation module (NIM) 202, a path planning module (PPM) 203, a trajectory planning module (TPM) 204, a trajectory plan projection on image module (TPPoIM) 205, an AI analysis and trajectory suggestion module (AA&TSM) 206, a velocity generation module (VGM) 207, and a vehicle localization module (VLM) 208. It should be noted that, in some embodiments, the aforementioned modules 201-208 may be a part of the navigation device 101 in the system 200. As will be appreciated, the system 200 may also include various other modules than those mentioned above so as to control and navigate the AGV. Further, as will be appreciated by those skilled in the art, all such aforementioned modules 201-208 may be represented as a single module or a combination of different modules. Moreover, as will be appreciated by those skilled in the art, each of the modules 201-208 may reside, in whole or in parts, on one device or multiple devices in communication with each other.

The AMTM 201 may create and train an AI model to learn alternative positions and velocity for the AGV upon detection of one or more anomalies in the road segment. It should be noted that the alternative position and velocity may be close to the initial trajectory plan generated for the AGV. Thus, for example, the AI model may be trained to determine alternative position and velocity, close to the initial trajectory plan, in a significant dent area on the visible road region. The AMTM 201 may receive camera images 209 with image annotations as a part of the training data to perform training of the AI model. The image annotations for an image of a road region may include features such as planned trajectory waypoints in the road region, lateral shift direction to navigate around one or more anomalies in the road region, adjusted trajectory waypoints to navigate around the one or more anomalies in the road region, velocity for navigating on the plurality of adjusted trajectory waypoints in the road region, category and severity of each of the one or more anomalies in the road region, and so forth.

The NIM 202 may be configured to initiate the navigation process to autonomously drive the AGV from source to the destination. In particular, the NIM 202 may provide a user interface (UI) for the system 200. The UI may display a navigation map along with a current location of the AGV to a user. The user may provide inputs to the system 200 via the UI. For example, the user may provide a destination location by touching any point (on a drivable road area) on the navigation map. This may initiate the navigation process from path planning, to velocity generation, to autonomous navigation from the source (i.e., the current location) to the destination (i.e., the destination location).

The PPM 203 may receive instant location of the AGV on the navigation map from the VLM 208. Further, the PPM 203 may receive the destination location from the NIM 202 so as to plan path and start navigation. The PPM 203 may then produce the base path for AGV's navigation from the instant or current location to the destination location using any path planning algorithm. This base path may also be referred to as navigation path or global path.

It should be noted that, for instant motion, the AGV may need detailed information on a section of the global path, e.g., possibly 10-15 meters ahead of the current location on the global path. The TPM 204 may generate a suitable trajectory plan for this initial distance based on current environment data, position and orientation of the AGV, and instant speed of the AGV. The trajectory plan is velocity-position plan for the AGV for next few meters distance from vehicle's instant position. The trajectory plan may be handed over to the VGM 207 for actual velocity generation. The trajectory plan may also be dynamically modified upon detecting any anomaly in the road segment, in accordance with some embodiments of the present disclosure.

The TPPoIM 205 may receive a base trajectory plan segment from the TPM 204. Additionally, the TPPoIM 205 may receive an instant image of visible road region ahead of the AGV from an imaging device. The imaging device may be one or more of the vision sensor(s) deployed by the vehicle. For example, the imaging device may be an infrared camera and a LiDAR. As will be appreciated, infrared camera image may be used to ensure better imaging in day as well as in night. In some embodiments, the TPPoIM 205 in conjunction with imaging device may acquire image of region where the trajectory plan fails. The TPPoIM 205 may then project planned trajectory waypoints on the image. Further, the TPPoIM 205 may segment the visible road region in the image into multiple equidistant segments along a road length. For example, based on projected points coordinate, the TPPoIM 205 may perform a distance wise road image segmentation. The TPPoIM 205 may then provide the image segments holding parts of the trajectory plan to the AA&TSM 206 for analysis of road properties at some uniform distance covered by each of the image segments.

The AA&TSM 206 may receive the image segments from the TPPoIM 205 and the trained AI model from the AMTM 201. The AA&TSM 206 may then identify inputs parameters for every region, and all successive region, around the initial planned trajectory (i.e., trajectory that vehicle was to follow) using the AI model. As will be appreciated, multiple consecutive image regions may be passed through the AI model along with few supporting information such as previous regions adjusted waypoint position, lateral shift direction, vehicle velocity in order to get new possible positions (i.e., alternate trajectory waypoints) and a suggested velocity for the region. The AA&TSM 206 may further determine the adjusted trajectory waypoint for the region based on the alternate trajectory waypoints and the suggested velocity. In some embodiments, the adjusted trajectory waypoint may be determined by adjusting alternate trajectory waypoints in the region based on the suggested velocity for the region and a safe turn angle for the suggested velocity. It should be noted that the safe turn angle for the suggested velocity is pre-configured for the AGV.

The VGM 207 may receive modified trajectory plan from AA&TSM 206 and generate a realistic velocity for the AGV. In particular, the VGM 207 may generate the realistic velocity based on previous moment velocity and the projected velocity as per the modified trajectory plan and based on the trajectory-velocity plan. The velocity generation may happen in certain frequency of, say, 100 millisecond (ms) and applied to the AGV's wheelbase. Additionally, the VGM 207 may observe a next moment velocity for further computation of realistic velocity. Moreover, the VGM 207 may provide feedback with respect to wheelbase data (e.g., odometer data), orientation sensor data (e.g., NU data), and environmental data (e.g., the vision sensor data), etc. to the VLM 208.

The VLM 208 may receive the vehicle orientation data. Further, while the AGV is in motion, the VLM 208 may collect wheelbase feedback data, navigation map data, and current environment observation data (e.g., LiDAR point cloud data). Based on the received or collected data, the VLM 208 may continuously localize the position of the AGV on the navigation map with respect to the environment. Thus, the VLM 204 may be responsible for indicating an instant location of the AGV on the navigation map while performing navigation. Any further global path planning or trajectory planning may start from this instant location.

It should be noted that all such aforementioned modules 201-208 may be implemented in programmable hardware devices such as programmable gate arrays, programmable array logic, programmable logic devices, or the like. Alternatively, all such aforementioned modules 201-208 may be implemented in software for execution by various types of processors. An identified module of executable code may, for instance, include one or more physical or logical blocks of computer instructions which may, for instance, be organized as an object, procedure, function, or other construct. Nevertheless, the executables of an identified module need not be physically located together, but may include disparate instructions stored in different locations which, when joined logically together, comprise the module and achieve the stated purpose of the module. Indeed, a module of executable code may be a single instruction, or many instructions, and may even be distributed over several different code segments, among different applications, and across several memory devices.

As will be appreciated by one skilled in the art, a variety of processes may be employed for dynamically modifying navigation trajectory of an AGV during real-time navigation. For example, the exemplary system 100 and the associated navigation device 101 may dynamically modify navigation trajectory of the AGV 105 during real-time navigation by the processes discussed herein. In particular, as will be appreciated by those of ordinary skill in the art, control logic and/or automated routines for performing the techniques and steps described herein may be implemented by the system 100 and the associated navigation device 101, either by hardware, software, or combinations of hardware and software. For example, suitable code may be accessed and executed by the one or more processors on the system 100 or the associated navigation device 101 to perform some or all of the techniques described herein. Similarly, application specific integrated circuits (ASICs) configured to perform some or all of the processes described herein may be included in the one or more processors on the system 100 or on the associated navigation device 101.

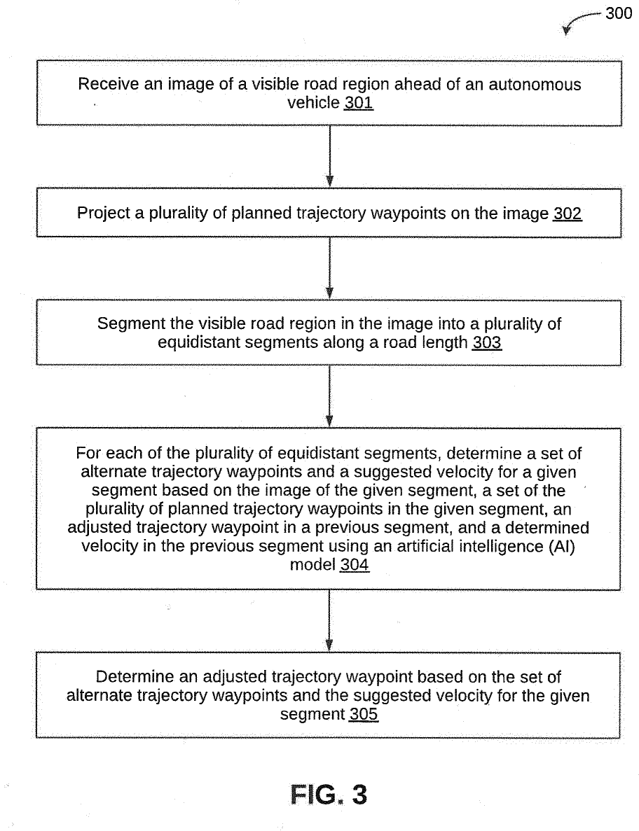

For example, referring now to FIG. 3, exemplary control logic 300 for dynamically modifying navigation trajectory of the AGV during real-time navigation via a system, such as the system 100 or the associated navigation device 101, is depicted via a flowchart, in accordance with some embodiments of the present disclosure. As illustrated in the flowchart, the control logic 300 may include the steps of receiving an image of a visible road region ahead of an AGV at step 301, projecting a plurality of planned trajectory waypoints on the image at step 302, and segmenting the visible road region in the image into a plurality of equidistant segments along a road length at step 303. For each of the plurality of equidistant segments, the control logic 300 may further include the step of determining a set of alternate trajectory waypoints and a suggested velocity for a given segment based on the image of the given segment, a set of the plurality of planned trajectory waypoints in the given segment, an adjusted trajectory waypoint in a previous segment, and a determined velocity in the previous segment using an artificial intelligence (AI) model at step 304. Additionally, for each of the plurality of equidistant segments, the control logic 300 may include the step of determining an adjusted trajectory waypoint based on the set of alternate trajectory waypoints and the suggested velocity for the given segment at step 305.

In some embodiments, receiving the image at step 301 may include the step of capturing the image of the visible road region using an imaging device. Additionally, in some embodiments, segmenting the image at step 303 may include the step of segmenting the image based on projection of LiDAR points on the image.

In some embodiments, the control logic 300 may further include the step of training the AI model with a plurality of images of a plurality of road regions. In such embodiments, each of the plurality of images in the training data comprises one or more annotatable features. Further, in such embodiments, the annotatable features may include, but may not be limited to, a plurality of planned trajectory waypoints in a road region, a lateral shift direction to navigate around one or more anomalies in the road region, a plurality of adjusted trajectory waypoints to navigate around the one or more anomalies in the road region, a velocity for navigating on the plurality of adjusted trajectory waypoints in the road region, a category of each of the one or more anomalies in the road region, and a severity of each of the one or more anomalies in the road region.

In some embodiments, determining the adjusted trajectory waypoint in the given segment at step 305 may include the step of adjusting the set of alternate trajectory waypoints in the given segment based on the suggested velocity for the given segment and a safe turn, angle for the suggested velocity. It should be noted that the safe turn angle for the suggested velocity is pre-configured for the AGV. Additionally, in some embodiments, adjusting the set of alternate trajectory waypoints may include the steps of determining an approximate trajectory waypoint for the given segment by averaging the set of alternate trajectory waypoints falling within the given segment, determining an angle between two adjacent imaginary line connecting the approximate trajectory waypoint for the given segment with a planned or an adjusted trajectory waypoint for a previous segment and a planned or an approximate trajectory waypoint for a next segment, and adjusting the approximate trajectory waypoint for the given segment in a lateral direction based on the angle and the safe turn angle for the suggested velocity.

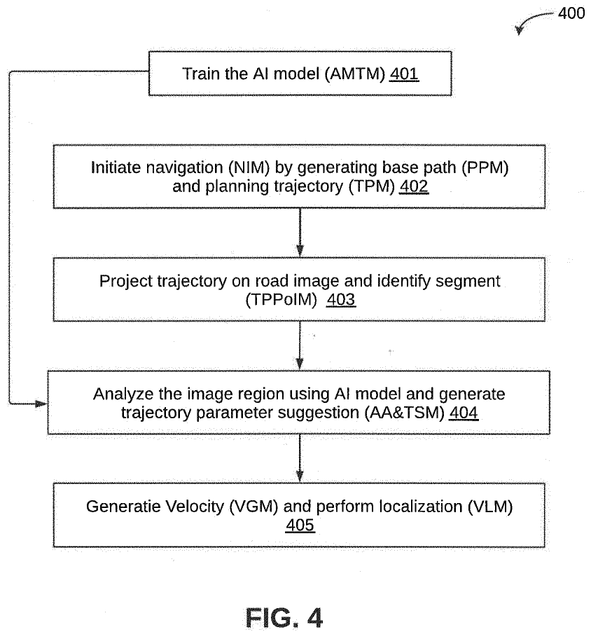

Referring now to FIG. 4, an exemplary process 400 for dynamically modifying navigation trajectory of the AGV during real-time navigation is depicted in greater detail via a flowchart, in accordance with some embodiments of the present disclosure. At step 401, the AMTM 201 may train the AI model using training data comprising images of road regions. As will be appreciated, the road regions may include non-drivable road region area near the trajectory path. Each of the training images may include image annotations (comprising one or more annotatable features) to be used as AI model input. The features may include, but may not be limited to, planned trajectory waypoints in the road region, lateral shift direction to navigate around one or more anomalies in the road region, adjusted trajectory waypoints to navigate around the one or more anomalies in the road region, velocity for navigating on the plurality of adjusted trajectory waypoints in the road region, and category and severity of each of the one or more anomalies in the road region.

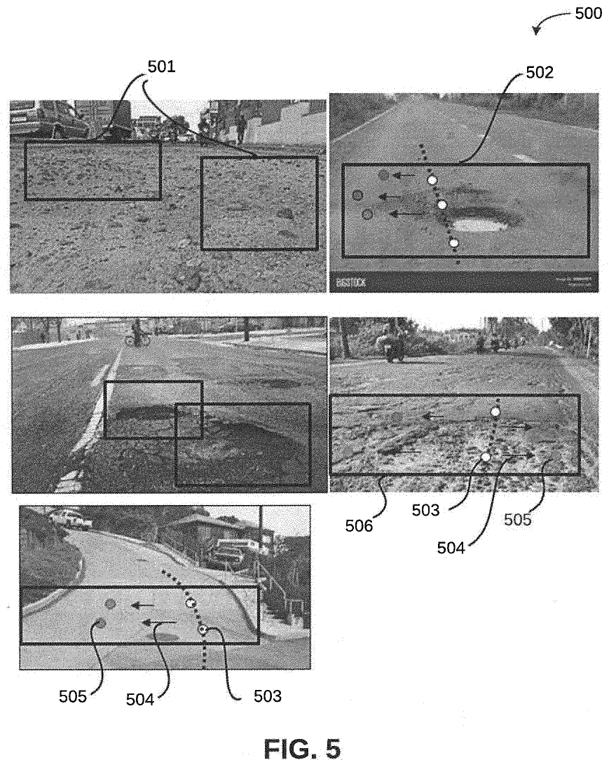

Referring now to FIG. 5, image annotations corresponding to multiple images (500) used for training an AI model is illustrated, in accordance with some embodiments of the present disclosure. As illustrated, the features that may be used for AI model training input may include, but may not be limited to, alignment due to lateral elevation variation, loose materials (stone, sand dusts etc.) on road surface 501, water filled section 502, base trajectory waypoints 503, shift direction (perpendicular to trajectory alignment of a segment) 504, speed of vehicle, alternate/adjusted trajectory waypoints 505, and dent in the road segment 506. The AI model is trained to identify safer waypoint positions and speed for refining the base trajectory plan. Further, the AI model may provide a) anomaly category and b) severity percentage, which may translate into c) a speed factor and d) safer position. Multiple safer waypoints and speed annotation may be done on road section for each scene image. Image region with specific annotatable features may be fed for training the AI model.

Referring back to FIG. 4, at step 402, the MM 202 may initiate the navigation process for the AGV to autonomously drive from the source location to the destination location. The NIM 202 may receive input with respect to a desired destination from the user via the UI. Upon receiving the input, the NIM 202 may initiate the navigation from path planning to velocity generation. Accordingly, the PPM 203 may generate a base path for vehicle's navigation from current vehicle location to the destination location. This part may also be referred to as path planning. For motion, vehicle needs some part of global path, possibly 10-20 meters ahead starting from global path point. This portion of path needs to be smoothened out to accommodate vehicle like motion at any instant. Thus, the TPM 204 may generate a trajectory plan for the AGV based on the current position and orientation of the AGV, base path of the AGV, current environment data with respect to the AGV, and the instant speed of the AGV.

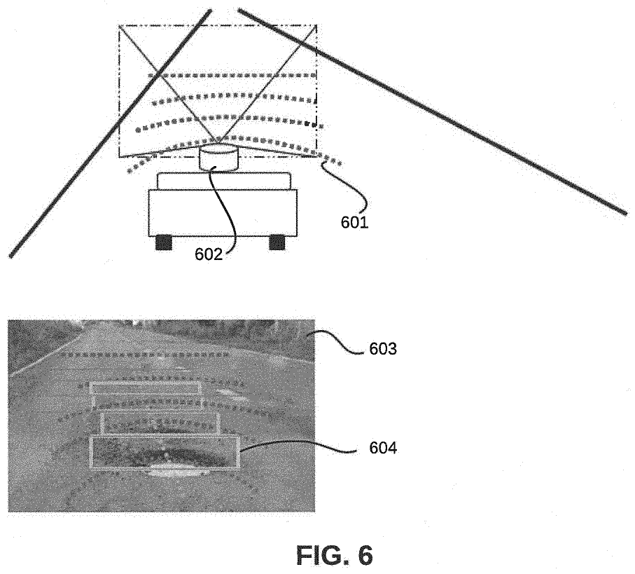

At step 403, the TPPoIM 205 may project the trajectory waypoints on drivable road region in the image and may segment the drivable road region into multiple equidistant road segments. Referring now to FIG. 6, projection of planned trajectory waypoints on an image and segmentation of visible road region in the image is illustrated, in accordance with some embodiments of the present disclosure. The TPPoIM 205 may identify LiDAR point reflection 601 from road surface only. This is done by considering the lowest elevation points within a conical field of view (FoV) of LiDAR 602. The TPPoIM 205 may find LiDAR points with ‘d’ threshold around the trajectory and virtually project this point on road extracted infrared image 603. These image positions or region where the base trajectory plan falls, may be used as reference points of input regions of AI model at runtime. A distance wise road image segmentation is performed based on LiDAR points projection on image. This indicates, which portion of the image is at what distance. In this way, the TPPoIM 205 may find the road properties at some uniform distance (say, 5 meters) covered by the image segment (also referred to as road segment) 604.

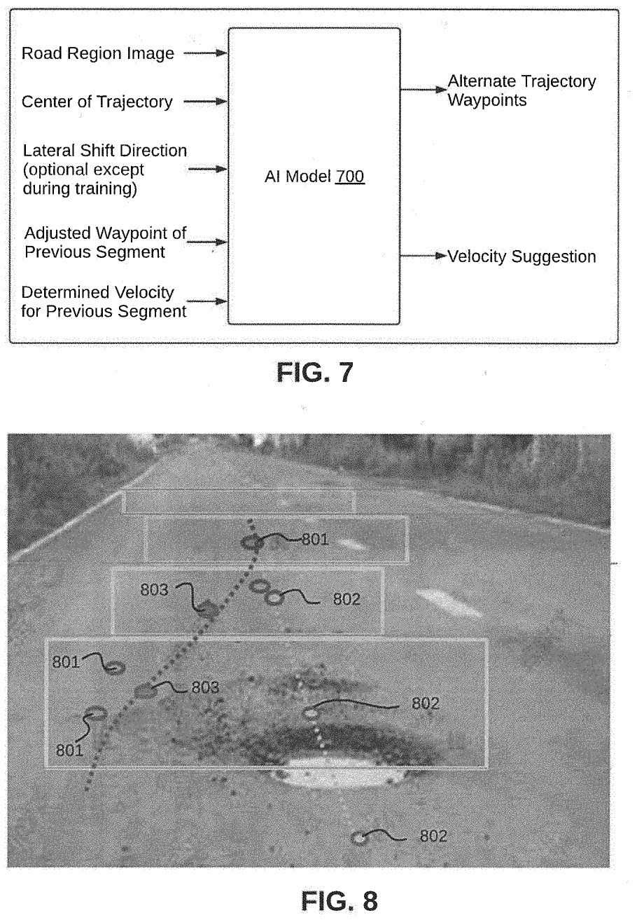

At step 404, the AA&TSM 206 may analyze the image region using the trained AI model and generate trajectory parameter suggestions. In particular, the AA&TSM 206 may send the portion of road region image near the projected trajectory waypoints through the trained AI model in order to determine alternate trajectory waypoints. Referring now to FIG. 7, a block diagram of an AI model for generating alternate trajectory waypoints is illustrated, in accordance with some embodiments of the present disclosure. For every region and for all successive region, inputs parameters may be identified, if any, around the trajectory that the AGV was to follow. The input parameters may then be used to generate output from the AI model 700. As discussed above, the input parameters may include, but may not be limited to, center of original trajectory, lateral shift direction from original trajectory (optional), adjusted waypoint suggestion for previous segment, and determined velocity for previous road segment.

Multiple consecutive image regions may be passed through the AI model 700 along with input parameters, Based on learning, the AI model 700 may produce alternate trajectory waypoints and a velocity suggestion for each road segment. In other words, the AI model 700 may determine alternate trajectory waypoints and velocity suggestion upon detecting anomaly on the road segment and based on the anomaly category.

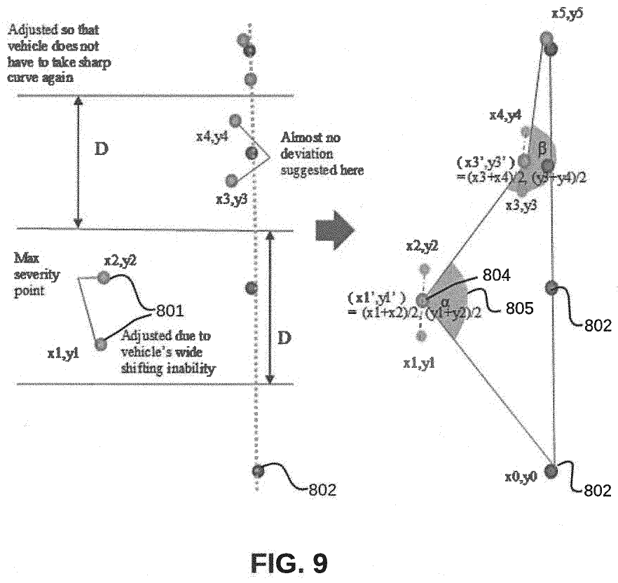

Referring now to FIG. 8, alternate trajectory waypoints 801 generated by the AI model 700 are illustrated along with planned trajectory waypoints 802 and adjusted trajectory waypoints 803, in accordance with some embodiments of the present disclosure. As will be described in greater detail in conjunction with FIGS. 9-11, for each of the road segments, the AA&TSM 206 may determine the adjusted trajectory waypoints 803 on a road segment based on the alternate trajectory waypoints 801 in the road segment and the suggested velocity for the road segment.

Referring now to FIG. 9, derivation of approximate trajectory waypoints 804 is illustrated, in accordance with some embodiments of the present disclosure. The series of alternate trajectory waypoints 801 in a road segment may be averaged to determine an approximate trajectory waypoint 804 in the road segment through which the modified trajectory may pass through. It should be noted that the approximate trajectory waypoint 804 may be calculated for each road segment. As illustrated, (x1′, y1′) and (x3′, y3′) are two such approximate trajectory waypoints determined form alternate trajectory waypoints (x1,y1), (x2,y2) and (x3,y3), (x4,y4) respectively. Further, the approximate trajectory waypoint 804 in a road segment may be connected to a planned or an adjusted trajectory waypoint in a previous segment using an imaginary line. Similarly, the approximate trajectory waypoint 804 in a road segment may be connected to a planned or an approximate trajectory waypoint in a next segment using another imaginary line. Further, an angle 805 between two such adjacent lines may be calculated. As illustrated, the angle between the imaginary line joining (x0, y0) and (x1′, y1′) and the imaginary lime joining (x1′, y1) and (x3′, y3′) is ‘a’. Similarly, the angle between the imaginary lime joining (x1′, y1′) and (x3′, y3′) and the imaginary lime joining (x3′, y3′) and (x5, y5) is ‘β’.

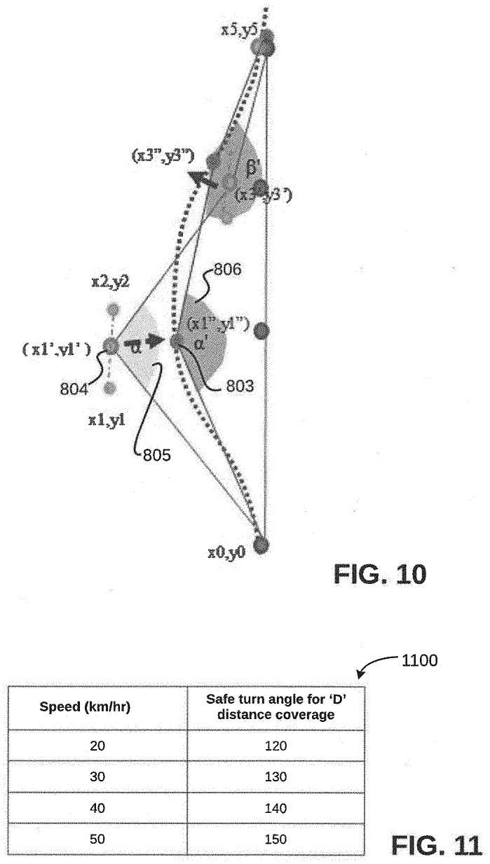

Referring now to FIG. 10, derivation of adjusted trajectory waypoints 803 from the approximate trajectory waypoints 804 is illustrated, in accordance with some embodiments of the present disclosure. The approximate trajectory waypoint 804 may be adjusted laterally based on the angle and the safe turn angle for the suggested velocity. Thus, the approximate trajectory waypoint 804 may be shifted gradually towards or away from the original trajectory, thereby seeking a new position such that the intersection line may produce an adjusted angle value 806 for each of ‘α’ & ‘β’ within the safe turn angle (say, greater than 150 degrees) for the speed at which AGV in navigating. Thus, the approximate trajectory waypoint (x1′, y1′) may be shifted to a new position (x1″, y1″), which may make the angle ‘α’ to ‘α′’. This new position (x1″, y1″) is the adjusted trajectory waypoint 803. Similarly, ‘β’ may also be made to ‘β′’ such that both the angle is within the safe turn angle (say, greater than 150 degrees). Finally, the AA&TSM 206 may combine newly identified adjusted trajectory points for each segment, to re-generate a new modified local trajectory using a standard curve fitting mechanism. The dynamically modified trajectory may avoid the road anomaly.

As will be appreciated, the safe turn angle value may vary based on vehicle turning capability on current velocity known from vehicle manufacturers profile parameters. In other words, the safe turn angle for the suggested velocity is pre-configured for the AGV. Referring now to FIG. 11, a table 1100 provides safe turn angle with respect to speed of the AGV, in accordance with some embodiments of the present disclosure. For a vehicle at lower speed, a lower turning radius value may be fine. However, if the vehicle is approaching at higher speed, it has to be given a higher angle of turn. Thus, ‘α’ to ‘α′’ change has to be adjusted by shifting waypoint (x1′,y1′) such that it is achievable for a vehicle approaching at a certain speed.

Referring back to FIG. 4, at step 405, the VGM 207 in conjunction with the VLM 208 may re-generate the trajectory plan by accounting for new adjusted trajectory waypoints. The VGM 207 may generate a realistic velocity based on previous moment velocity and the projected velocity as per the modified trajectory plan and based on the trajectory-velocity plan. This velocity generation may happen in certain frequency (say, 100 ms) and applied to the vehicle's wheelbase. A next moment velocity may be observed for further realistic velocity calculation. On application of the velocity, as the vehicle moves, the VLM 208 may determine new location of vehicle with respect to map. This may be done based on feedback from position sensor and based on matching vision sensor data with map data. It should be noted that such localization may be for indicating the vehicle on the navigation map while navigating, for further global path planning, or for further trajectory planning.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

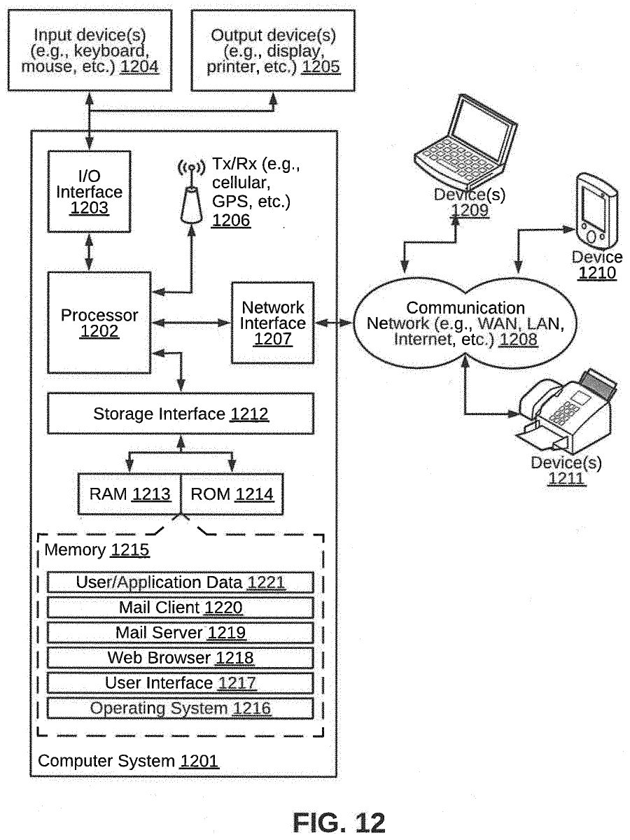

The disclosed methods and systems may be implemented on a conventional or a general-purpose computer system, such as a personal computer (PC) or server computer. Referring now to FIG. 12, a block diagram of an exemplary computer system 1201 for implementing embodiments consistent with the present disclosure is illustrated. Variations of computer system 1201 may be used for implementing the navigation device 101 or the system 100. Computer system 1201 may include a central processing unit (“CPU” or “processor”) 1202. Processor 1202 may include at least one data processor for executing program components for executing user-generated or system-generated requests. A user may include a person, a person using a device such as those included in this disclosure, or such a device itself. The processor 1202 may include specialized processing units such as integrated system (bus) controllers, memory management control units, floating point units, graphics processing units, digital signal processing units, etc. The processor 1202 may include a microprocessor, such as AMD® ATHLON®, DURON® OR OPTERON®, ARM's application, embedded or secure processors, IBM® POWERPC®, INTEL® CORE® processor, ITANIUM® processor, XEON® processor, CELERON® processor or other line of processors, etc. The process& 1202 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 1202 may be disposed in communication with one or more input/output (I/O) devices via I/O interface 1203. The I/O interface 1203 may employ communication protocols/methods such as, without limitation, audio, analog, digital, monoaural, RCA, stereo. IEEE-1394, near field communication (NFC), FireWire, Camera Link®, GigE, serial bus, universal serial bus (USB), infrared, PS/2, BNC, coaxial, component, composite, digital visual interface (DVI), high-definition multimedia interface (HDMI), radio frequency (RE) antennas, S-Video, video graphics array (VGA), IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like), etc.

Using the I/O interface 1203, the computer system 1201 may communicate with one or more I/O devices. For example, the input device 1204 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, altimeter, gyroscope, proximity sensor, or the like), stylus, scanner, storage device, transceiver, video device/source, visors, etc. Output device 1205 may be a printer, fax machine, video display (e.g., cathode ray tube (CRT), liquid crystal display (LCD), light-emitting diode (LED), plasma, or the like), audio speaker, etc. In some embodiments, a transceiver 1206 may be disposed in connection with the processor 1202. The transceiver 1206 may facilitate various types of wireless transmission or reception. For example, the transceiver 1206 may include an antenna operatively connected to a transceiver chip (e.g., TEXAS INSTRUMENTS° WILINK WL1286®, BROADCOM° BCM4550IUB8®, INFINEON TECHNOLOGIES® X-GOLD 618.PMB9800® transceiver, or the like), providing IEEE 802.11a/b/g/n, Bluetooth, FM, global positioning system (GPS), 2G/3G HSDPNHSUPA communications, etc.

In some embodiments, the processor 1202 may be disposed in communication with a communication network 1208 via a network interface 1207. The network interface 1207 may communicate with the communication network 1208. The network interface 1207 may employ connection protocols including, without limitation, direct connect, Ethernet (e.g., twisted pair 10/100/1000 Base T), transmission control protocol/internet protocol (TCP/IP), token ring, IEEE 802.11a/big/nix, etc. The communication network 1208 may include, without limitation, a direct interconnection, local area network (LAN), wide area network (WAN), wireless network (e.g., using Wireless Application Protocol), the Internet, etc. Using the network interface 1207 and the communication network 1208, the computer system 1201 may communicate with devices 1209, 1210, and 1211. These devices 1209, 1210, and 1211 may include, without limitation, personal computer(s), server(s), fax machines, printers, scanners, various mobile devices such as cellular telephones, smartphones (e.g., APPLE® IPHONE®, BLACKBERRY® smartphone, ANDROID® based phones, etc.), tablet computers, eBook readers (AMAZON® KINDLE®, NOOK® etc.), laptop computers, notebooks, gaming consoles (MICROSOFT® XBOX®, NINTENDO® DS®, SONY® PLAYSTATION®, etc.), or the like. In some embodiments, the computer system 1201 may itself embody one or more of these devices 1209, 1210, and 1211.

In some embodiments, the processor 1202 may be disposed in communication with one or more memory devices 1215 (e.g., RAM 1213, ROM 1214, etc.) via a storage interface 1212. The storage interface 1212 may connect to memory devices 1215 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), STD Bus, RS-232, RS-422, RS-485, I2C, SPI, Microwire, 1-Wire, IEEE 1284, Intel® QuickPathInterconnect, InfiniBand, PCle, etc. The memory drives may further include a drum, magnetic disc drive, magneto-optical drive, optical drive, redundant array of independent discs (RAID), solid-state memory devices, solid-state drives, etc.

The memory devices 1215 may store a collection of program or database components, including, without limitation, an operating system 1216, user interface application 1217, web browser 1218, mail server 1219, mail client 1220, user/application data 1221 (e.g., any data variables or data records discussed in this disclosure), etc. The operating system 1216 may facilitate resource management and operation of the computer system 1201. Examples of operating systems 1216 include, without limitation, APPLE® MACINTOSH® OS X, UNIX, Unix-like system distributions (e.g., Berkeley Software Distribution (BSD), FreeBSD, NetBSD, OpenBSD, etc.), Linux distributions (e.g., RED HAT®, UBUNTU®, KUBUNTU®, etc.), IBM° OS/2, MICROSOFT® WINDOWS® (XP®, Vista®/7/8, etc.), APPLE® IOS®, GOOGLE® ANDROID®, BLACKBERRY® OS, or the like. User interface 1217 may facilitate display, execution, interaction, manipulation, or operation of program components through textual or graphical facilities. For example, user interfaces 1217 may provide computer interaction interface elements on a display system operatively connected to the computer system 1201, such as cursors, icons, check boxes, menus, scrollers, windows, widgets, etc. Graphical user interfaces (GUIs) may be employed, including, without limitation, APPLE® MACINTOSH® operating systems' AQUA® platform, IBM® OS/2®, MICROSOFT® WINDOWS® (e.g., AERO®, METRO®, etc.), UNIX X-WINDOWS, web interface libraries (e.g., ACTIVEX®, JAVA®, JAVASCRIPT®, AJAX®, HTML, ADOBE® FLASH®, etc.), or the like.

In some embodiments, the computer system 1201 may implement a web browser 1218 stored program component. The web browser 1218 may be a hypertext viewing application, such as MICROSOFT® INTERNET EXPLORER®. GOOGLE® CHROME®, MOZILLA® FIREFOX®, APPLE® SAFARI®, etc. Secure web browsing may be provided using HTTPS (secure hypertext transport protocol), secure sockets layer (SSL), Transport Layer Security (TLS), etc. Web browsers 1218 may utilize facilities such as AJAX®, DHTML, ADOBE® FLASH®, JAVASCRIPT®, JAVA®, application programming interfaces (APIs), etc. In some embodiments, the computer system 1201 may implement a mail server 1219 stored program component. The mail server 1219 may be an Internet mail server such as MICROSOFT® EXCHANGE®, or the like. The mail server 1219 may utilize facilities such as ASP, ActiveX, ANSI C++/C#, MICROSOFT .NET® CGI scripts, JAVA®, JAVASCRIPT®, PERL®, PHP®, PYTHON®, WebObjects, etc. The mail server 1219 may utilize communication protocols such as internet message access protocol (IMAP), messaging application programming interface (MAPI), MICROSOFT® EXCHANGE®, post office protocol (POP), simple mail transfer protocol (SMTP), or the like. In some embodiments, the computer system 1201 may implement a mail client 1220 stored program component. The mail client 1220 may be a mail viewing application, such as APPLE MAIL®. MICROSOFT ENTOURAGE®, MICROSOFT OUTLOOK®, MOZILLA THUNDERBIRD®, etc.

In some embodiments, computer system 1201 may store user/application data 1221, such as the data, variables, records, etc. (e.g., base path, trajectory plan, trajectory waypoints, image of visible road region, projection of trajectory waypoints on the image, segmented portions of the image corresponding to equidistant segments, alternate trajectory waypoints for each segment, suggested or determined velocity for each segment, approximate trajectory waypoints for each segment, adjusted trajectory waypoints for each segment, AI model, training data comprising multiple images with image annotations, safe turn angle table, and so forth) as described in this disclosure. Such databases may be implemented as fault-tolerant, relational, scalable, secure databases such as ORACLE® OR SYBASE®. Alternatively, such databases may be implemented using standardized data structures, such as an array, hash, linked list, struct, structured text file (e.g., XML), table, or as object-oriented databases (e.g., using OBJECTSTORE®, POET®, ZOPE®, etc.). Such databases may be consolidated or distributed, sometimes among the various computer systems discussed above in this disclosure. It is to be understood that the structure and operation of the any computer or database component may be combined, consolidated, or distributed in any working combination.

As will be appreciated by those skilled in the art, the techniques described in the various embodiments discussed above are not routine, or conventional, or well understood in the art. The techniques discussed above provide for detecting anomalies in the road segments during real-time navigation of the AGV and further for dynamically modifying navigation trajectory of the AGV in order to avoid the anomalies. In other words, the AGV may detect and avoid anomalies in road segments that may have been otherwise unavoidable by standard trajectory plan. Thus, the techniques discussed above make the AGV more intelligent with respect to determining and taking safer trajectory and with respect to speed control and adjustment.

The techniques described in the various embodiments discussed above provide for training an AI model with various road anomaly image and annotating the safe position considering a lateral shift and a velocity suggestion on this type of region. Further, during real-time navigation, the base trajectory plan may be projected into a road image captured by frontal camera in order to identify the region of interest at equal separation for road anomaly. Then, each of this region may be provided to the trained AI model to get new waypoints suggestion with velocity suggestion. These new waypoints may then be employed to generate a modified trajectory for velocity generation.

It should be noted that the techniques described above provide for a novel pre-processing of sensor data for the learned AI model to determine trajectory waypoints suggestion (i.e., alternate trajectory waypoints). Additionally, the techniques described above provide for a novel mechanism to further adjust the alternate trajectory waypoints to generate a fine-tuned trajectory (i.e., adjusted trajectory waypoints). For example, the techniques provide for necessary adjustment required on trajectory waypoint based on road conditions anomaly. Also, the techniques provide for further adjustment on waypoints depending on factory data of vehicle capability for a followable trajectory path.

The specification has described method and system for dynamically modifying navigation trajectory of an AGV during real-time navigation. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with, the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of dynamically modifying a trajectory of an autonomous ground vehicle (AGV) during real-time navigation, the method comprising:
receiving, by a navigation device, an image of a visible road region ahead of an AGV;
projecting, by the navigation device, a plurality of planned trajectory waypoints on the image;
segmenting, by the navigation device, the visible road region in the image into a plurality of equidistant segments along a road length; and
for each of the plurality of equidistant segments,
determining, by the navigation device, a set of alternate trajectory waypoints and a suggested velocity for a given segment based on the image of the given segment, a set of the plurality of planned trajectory waypoints in the given segment, an adjusted trajectory waypoint in a previous segment, and a determined velocity in the previous segment using an artificial intelligence (AI) model; and
determining, by the navigation device, an adjusted trajectory waypoint based on the set of alternate trajectory waypoints and the suggested velocity for the given segment.

2. The method of claim 1, wherein receiving the image comprises capturing the image of the visible road region using an imaging device.

3. The method of claim 1, wherein segmenting the image comprises segmenting the image based on projection of LiDAR points on the image.

4. The method of claim 1, further comprising training the AI model with a plurality of images of a plurality of road regions, wherein each of the plurality of images comprises one or more annotatable features comprising:
a plurality of planned trajectory waypoints in a road region,
a lateral shift direction to navigate around one or more anomalies in the road region,
a plurality of adjusted trajectory waypoints to navigate around the one or more anomalies in the road region,
a velocity for navigating on the plurality of adjusted trajectory waypoints in the road region, and
optionally one or more of:
a category of each of the one or more anomalies in the road region, and
a severity of each of the one or more anomalies in the road region.

5. The method of claim 1, wherein determining the adjusted trajectory waypoint in the given segment comprises adjusting the set of alternate trajectory waypoints in the given segment based on the suggested velocity for the given segment and a safe turn angle for the suggested velocity, and wherein the safe turn angle for the suggested velocity is pre-configured for the AGV.

6. The method of claim 5, wherein adjusting the set of alternate trajectory waypoints comprises:
determining an approximate trajectory waypoint for the given segment by averaging the set of alternate trajectory waypoints falling within the given segment;
determining an angle between two adjacent imaginary line connecting the approximate trajectory waypoint for the given segment with a planned or an adjusted trajectory waypoint for a previous segment and a planned or an approximate trajectory waypoint for a next segment; and
adjusting the approximate trajectory waypoint for the given segment in a lateral direction based on the angle and the safe turn angle for the suggested velocity.

7. A system for dynamically modifying a trajectory of an autonomous ground vehicle (AGV) during real-time navigation, the system comprising:
a navigation device comprising at least one processor and a computer-readable medium storing instructions that, when executed by the at least one processor, cause the at least one processor to perform operations comprising:
receiving an image of a visible road region ahead of an AGV;
projecting a plurality of planned trajectory waypoints on the image;
segmenting the visible road region in the image into a plurality of equidistant segments along a road length; and
for each of the plurality of equidistant segments,
determining a set of alternate trajectory waypoints and a suggested velocity for a given segment based on the image of the given segment, a set of the plurality of planned trajectory waypoints in the given segment, an adjusted trajectory waypoint in a previous segment, and a determined velocity in the previous segment using an artificial intelligence (AI) model; and
determining an adjusted trajectory waypoint based on the set of alternate trajectory waypoints and the suggested velocity for the given segment.

8. The system of claim 7, wherein receiving the image comprises capturing the image of the visible road region using an imaging device.

9. The system of claim 7, wherein segmenting the image comprises segmenting the image based on projection of LiDAR points on the image.

10. The system of claim 7, wherein the operations further comprise training the AI model with a plurality of images of a plurality of road regions, and wherein each of the plurality of images comprises one or more annotatable features comprising:
a plurality of planned trajectory waypoints in a road region,
a lateral shift direction to navigate around one or more anomalies in the road region,
a plurality of adjusted trajectory waypoints to navigate around the one or more anomalies in the road region,
a velocity for navigating on the plurality of adjusted trajectory waypoints in the road region, and
optionally one or more of:
a category of each of the one or more anomalies in the road region, and
a severity of each of the one or more anomalies in the road region.

11. The system of claim 7, wherein determining the adjusted trajectory waypoint in the given segment comprises adjusting the set of alternate trajectory waypoints in the given segment based on the suggested velocity for the given segment and a safe turn angle for the suggested velocity, and wherein the safe turn angle for the suggested velocity is pre-configured for the AGV.

12. The system of claim 11, wherein adjusting the set of alternate trajectory waypoints comprises:
determining an approximate trajectory waypoint for the given segment by averaging the set of alternate trajectory waypoints falling within the given segment;
determining an angle between two adjacent imaginary line connecting the approximate trajectory waypoint for the given segment with a planned or an adjusted trajectory waypoint for a previous segment and a planned or an approximate trajectory waypoint for a next segment; and
adjusting the approximate trajectory waypoint for the given segment in a lateral direction based on the angle and the safe turn angle for the suggested velocity.

13. A non-transitory computer-readable medium storing computer-executable instructions dynamically modifying a trajectory of an autonomous ground vehicle (AGV) during real-time navigation, the computer-executable instructions configured for:
receiving an image of a visible road region ahead of an AGV;
projecting a plurality of planned trajectory waypoints on the image;
segmenting the visible road region in the image into a plurality of equidistant segments along a road length; and
for each of the plurality of equidistant segments,
determining a set of alternate trajectory waypoints and a suggested velocity for a given segment based on the image of the given segment, a set of the plurality of planned trajectory waypoints in the given segment, an adjusted trajectory waypoint in a previous segment, and a determined velocity in the previous segment using an artificial intelligence (AI) model; and
determining an adjusted trajectory waypoint based on the set of alternate trajectory waypoints and the suggested velocity for the given segment.

14. The non-transitory computer-readable medium of claim 13, wherein receiving the image comprises capturing the image of the visible road region using an imaging device.

15. The non-transitory computer-readable medium of claim 13, wherein segmenting the image comprises segmenting the image based on projection of LIDAR points on the image.

16. The non-transitory computer-readable medium of claim 13, wherein the computer-executable instructions are further configured for training the AI model with a plurality of images of a plurality of road regions, and wherein each of the plurality of images comprises one or more annotatable features comprising:
a plurality of planned trajectory waypoints in a road region,
a lateral shift direction to navigate around one or more anomalies in the road region,
a plurality of adjusted trajectory waypoints to navigate around the one or more anomalies in the road region,
a velocity for navigating on the plurality of adjusted trajectory waypoints in the road region, and
optionally one or more of:
a category of each of the one or more anomalies in the road region, and
a severity of each of the one or more anomalies in the road region.

17. The non-transitory computer-readable medium of claim 13, wherein determining the adjusted trajectory waypoint in the given segment comprises adjusting the set of alternate trajectory waypoints in the given segment based on the suggested velocity for the given segment and a safe turn angle for the suggested velocity, and wherein the safe turn angle for the suggested velocity is pre-configured for the AGV.

18. The non-transitory computer-readable medium of claim 17, wherein adjusting the set of alternate trajectory waypoints comprises:
determining an approximate trajectory waypoint for the given segment by averaging the set of alternate trajectory waypoints falling within the given segment;
determining an angle between two adjacent imaginary line connecting the approximate trajectory waypoint for the given segment with a planned or an adjusted trajectory waypoint for a previous segment and a planned or an approximate trajectory waypoint for a next segment; and
adjusting the approximate trajectory waypoint for the given segment in a lateral direction based on the angle and the safe turn angle for the suggested velocity.
